(19) United States
(12) Patent Application Publication
(10) Pub. No.: US 2011/0270782 A1
(43) Pub. Date: Nov. 3, 2011

(54) SYSTEMS AND METHODS FOR DETERMINING INVESTMENT STRATEGIES

(75) Inventors: Robert F. Trenner, Kirkland, WA (US); Kenneth M. Hart, Issaquah, WA (US); Jeffrey A. Huse, Seattle, WA (US); Michael Milojevich, Issaquah, WA (US)

(73) Assignee: Cornerstone Advisors Inc., Bellevue, WA (US)

(21) Appl. No.: 12/771,956

(22) Filed: Apr. 30, 2010

(51) Int. Cl. G06Q 40/00

(52) U.S. Cl. 705/36 T; 705/36 R

(57) ABSTRACT

An investment strategy determines changes of a value of an asset portfolio over the time of a study period. For each of the incremental periods of the study period, an exemplary embodiment retrieves from a memory a base parameter value for the incremental period, wherein the base parameter value corresponds to one of a base inflation value, a base asset return value, and a base tax value; determines a first iteration parameter value based upon a statistical function associated with the base parameter value; and determines a value of an asset portfolio based upon the first iteration parameter value and the second iteration parameter value. A financial report is generated based upon the determined value of the asset portfolio for each of the incremental periods, wherein the generated financial report indicates changes of the value of the asset portfolio over the study period.

### BACKGROUND

1. Technical Field

The present disclosure relates to techniques for determining investment strategies and, in particular, to methods and systems for iteratively determining asset portfolio valuations based on statistical functions that represent various financial assumptions such as tax rate, asset return, inflation, and the like.

2. Description of Related Art

Clients often seek the advice of a financial consultant when determining an investment strategy. For example, retirement planning is a very complicated process of developing a long term investment strategy which will meet the projected financial needs of the client during their retirement years. During their working careers, clients may choose to invest their earnings, and invest other assets that they have or acquire, in a variety of financial instruments. Exemplary financial instruments include stocks, mutual funds, money market accounts, bonds, bond funds, real estate trusts, etc. Further, the financial instruments may be held in different types of accounts that have different fee and tax structures. For example, qualified plans such as an individual retirement account (IRA), may be contributed to using pre-tax earnings where the earning from the financial instruments therein accumulate earning on a pre-tax basis. The client may also be interested in investing in other types of assets, such as art, real estate, or a business.

Integral to providing sound financial advice is the process of simulating various asset management strategies over relatively long periods of time. For example, a client may have twenty years of remaining career life ahead of them. Upon retirement, the client may expect to have thirty years of retirement. Based upon planned asset investments over the career life of the client, and in consideration of retirement benefits and other assets, annual amounts of asset expenditures may be determined for the expected retirement period of the client. Alternatively, based upon the desired asset expenditures of the client during their retirement period, the required annual asset contributions over the client's pre-retirement years may be determined such that their retirement account is adequately funded.

Typically, complex computer programs are run to simulate various financial strategies of the client. However, there are many unknown factors which come into play when evaluating the client's various financial strategies. For example, the assumed rate of inflation used during the financial simulations may not be the same as actual rates of inflation. Rate of return assumptions, such as a rate of return (ROR) or a return on assets (ROA), used during the financial simulations may be different from actual return rates. Further, assumed periods for income generation and/or retirement may vary. For example, the client may want to continue to work part time beyond their traditional retirement age. Alternatively, the client may be forced to take an early retirement due to unexpected health problems. And, the client may live longer than the anticipated life expectancy used during the financial simulations, thereby resulting in unanticipated expenses.

### SUMMARY

Systems and methods of determining investment strategies are disclosed. The investment strategy determines changes of a value of an asset portfolio over the time of a study period. For each of the incremental periods of the study period, an exemplary embodiment retrieves from a memory a base parameter value for the incremental period, wherein the base parameter value corresponds to one of a base inflation value, a base asset return value, and a base tax value; determines a first iteration parameter value based upon a statistical function associated with the base parameter value; and determines a value of an asset portfolio based upon the first iteration parameter value and the second iteration parameter value. A financial report is generated based upon the determined value of the asset portfolio for each of the incremental periods, wherein the generated financial report indicates changes of the value of the asset portfolio over the time of the study period

### BRIEF DESCRIPTION OF THE DRAWINGS

Various embodiments are described in detail below with reference to the following drawings:

FIG. 1 is a block diagram of an embodiment of the investment strategy system;

FIG. 2 is a block diagram illustrating selected elements of an exemplary embodiment of the investment strategy system;

FIG. 3 is a block diagram of an asset contribution schedule, an asset depletion schedule, and an asset earning schedule, of an embodiment of the investment strategy system;

FIG. 4 is a block diagram illustrating selected portions of the inflation iteration engine;

FIG. 5 illustrates a simplified table which conceptually illustrates the relationship between a study period, an incremental period, a base inflation value, and an iteration inflation value;

FIG. 6 conceptually illustrates the generation of iteration inflation values based upon the base inflation value and the statistical function;

FIG. 7 is a block diagram illustrating selected portions of the return iteration engine;

FIG. 8 illustrates a simplified table which conceptually illustrates the relationship between a study period, an incremental period, a base return value, and an iteration return value;

FIG. 9 conceptually illustrates a hypothetical statistical function for a return iteration engine;

FIG. 10 is a block diagram illustrating selected portions of the tax iteration engine residing in the memory system;

FIG. 11 illustrates a simplified table which conceptually illustrates the generation of iteration tax values based upon the base tax value and the statistical function;

FIG. 12 conceptually illustrates a hypothetical statistical function for a tax iteration engine;

FIG. 13 illustrates an asset depletion engine defined by a plurality of asset depletion components;

FIG. 14 illustrates a risk-based asset allocation engine defined by a plurality of risk-based asset allocation components and a risk-based factor schedule;

FIG. 15 illustrates a concentrated stock position asset allocation engine defined by a plurality of concentrated stock position asset allocation components and a concentrated stock position factor schedule;

FIG. 16 illustrates a correlation engine defined by a plurality of correlation components;

FIG. 17 illustrates an exemplary net asset contributions and depletions output report presented in graphical form;

FIG. 18 illustrates an exemplary range of returns output report presented in graphical form;

FIG. 19 illustrates an exemplary probable ending value output report presented in graphical form; and

FIG. 20 is an example flow diagram of an asset valuation process performed by an example embodiment.

### DETAILED DESCRIPTION

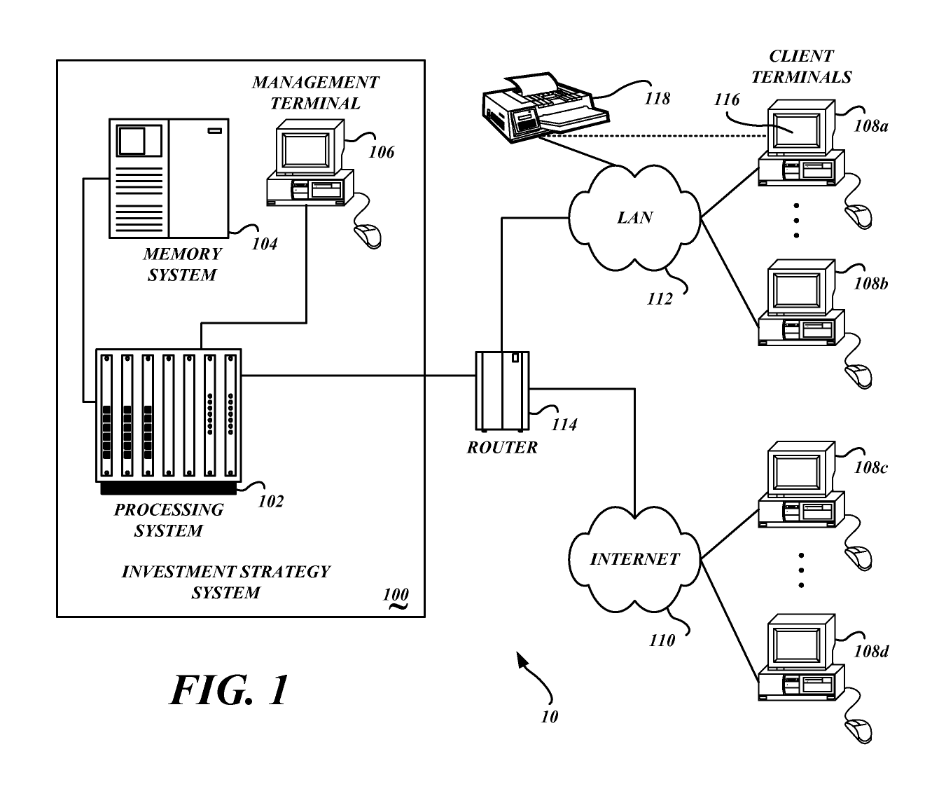

FIG. 1 is a block diagram of an embodiment of the investment strategy system 100 residing in a computing system 10. An exemplary embodiment of the investment strategy system 100 comprises a portion of the computing system 10, and includes a processor system 102, a memory system 104, and an optional management terminal 106. In an exemplary embodiment, the investment strategy system 100 is communicatively coupled to one or more client terminals 108a-108d, generally referred to as a client terminal 108. The client terminals 108 may be communicatively coupled to a service system, such as the Internet 110, a local area network (LAN) 112, or other service provider network. The service system may be communicatively coupled to the investment strategy system 100 via a suitable connection system, such as the exemplary router 114. Reports of the determined financial strategies may be presented on a display 116 of the client terminal 108. Additionally, or alternatively, a printer terminal 118 may be communicatively coupled to the investment strategy system 100 for reporting purposes.

A client (not shown) may operate the investment strategy system 100 remotely from a connected client terminal 108. The client may enter various financial data, such as a contribution schedule specifying asset contributions over the years of contribution, and investment allocation schedule defining the types of financial instruments in which contributed assets are invested in, and a depletion schedule specifying asset withdrawals over the years of retirement which will deplete the client's net assets. Optionally, the client may specify various financial assumptions that will be used to determine annual asset valuations of the client based upon asset contributions or asset withdrawals. Exemplary assumptions include, but are not limited to, assumptions regarding ROR, ROA, inflation, etc.

Based upon the financial data provided by the client, and based upon a plurality of financial assumptions, embodiments of the investment strategy system 100 determine investment strategies for the client. The investment strategies may be presented to the client in a variety of formats, such as presentation of the financial strategies on a display 116 of the client terminal 108 or a printout generated by the printer terminal 118.

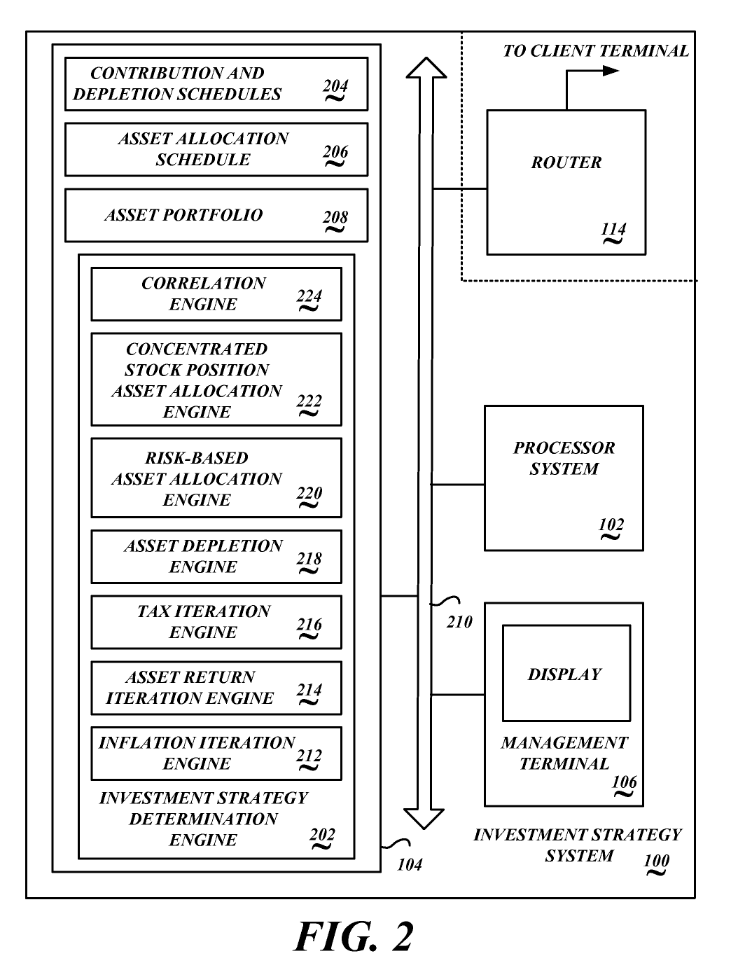

FIG. 2 is a block diagram illustrating selected elements of an exemplary embodiment of the investment strategy system 100. The processor system 102 may be any suitable processor or processor device. The processor system 102 may be a commercially available processor. Examples of commercially available processors include, but are not limited to, an x86 microprocessor, Power PC microprocessor, SPARC processor, PA-RISC processor or 68000 series microprocessor. In other embodiments, the processor system 102 may be a mainframe type processor system. The processor system 102 may be a specially designed and fabricated processor, or may be part of a multi-purpose processor system, in accordance with embodiments of the investment strategy system 100.

The memory system 104 may be any suitable memory system and/or media. The memory system 104 may be a stand alone memory system that is directly accessed by the investment strategy system 100. Alternatively, or additionally, the memory system 104 may be integrated into the processor system 102. Further, the memory system 104 may comprise a plurality of discrete memory units or modules that are accessible by the processor system 102. In some embodiments, the memory system 104 may be remote from the location of the processor system 102. The various information, data, and logic associated with embodiments of the processor system 102 may reside in any suitable portion or location of the memory system 104.

Embodiments of the investment strategy system 100 are implemented in the computing system 10 and may include a strategy determination engine 202 which, when executed, enables a plurality of financial simulations to be conducted. The financial simulations present information to assist a user in developing one or more economic strategies for their assets.

To facilitate a conceptual description of various investment strategy system 100 embodiments, the strategy determination engine 202 is described as comprising a plurality of engines and financial-related information that act cooperatively to perform the financial simulations. An exemplary embodiment of the investment strategy system 100 comprises a strategy determination engine 202, contribution and depletion schedules 204, an asset allocation schedule 206, and an asset portfolio 208. The exemplary strategy determination engine 202 includes an inflation iteration engine 212, an asset return iteration engine 214, a tax iteration engine 216, an asset depletion engine 218, a risk-based asset allocation engine 220, a concentrated stock position asset allocation engine 222, and a correlation engine 224. It is appreciated that alternative embodiments may include more components and/or engines than are described herein, or may have fewer components and/or engines than are described herein. Further, two or more of the components and/or engines may be integrated together into a single component and/or engine. In some embodiments, the components and/or engines may reside separately from each other in different memory media. Such media may reside locally with each other, and/or may reside remote from each other.

Upon receipt of an initialization request from a client, embodiments of the investment strategy system 100 retrieve and execute the investment strategy determination engine 202. In some embodiments, the investment strategy determination engine 202 is downloaded into the processor system 102 and executed thereon. Such an embodiment receives information from the client terminal 108 and provides reports pertaining to the determined investment strategies to the client terminal 108.

In other embodiments, the investment strategy determination engine 202 is downloaded into the client terminal 108 such that the investment strategy system 100 virtually resides in the client terminal 108. Similarly, associated data and financial assumptions used by the executing investment strategy determination engine 202 may be retrieved and downloaded from the memory system 104 into the client terminal 108. Other data and/or financial assumptions may reside locally in a memory of the client terminal 108 and may then be accessed as needed by the executing investment strategy determination engine 202.

In yet other embodiments, the investment strategy system 100 may be implemented on a stand-alone system that may be installed on personal computer, such as the exemplary client terminal 108. Such embodiments lend themselves to various marketing strategies, and also eliminate the need to communicate to a remote processor over a service system, such as the Internet 110, a local area network (LAN) 112, or other service provider network.

When investment strategy determination engine 202 is implemented as software and stored in memory system 104, one skilled in the art will appreciate that the investment strategy determination engine 202 can be stored as executable logic on any computer-readable medium for use by or in connection with any computer and/or processor related system or method. In the context of this disclosure, a memory system 104 is a computer-readable medium that is an electronic, magnetic, optical, or other another physical device or means that contains, transmits, or stores a computer and/or processor program. The investment strategy determination engine 202 may be embodied in any computer-readable medium for use by or in connection with an instruction execution system, apparatus, or device, such as a computer-based system, processor-containing system, or other system that can fetch the instructions from a computer-readable medium and execute the fetched instructions associated with investment strategy determination engine 202. In the context of this disclosure, a “computer-readable medium” can be any means that can store, communicate, propagate, or transport the program associated with investment strategy determination engine 202 for use by or in connection with the instruction execution system, apparatus, and/or device. The computer-readable medium can be, for example, but is not limited to, an electronic, magnetic, optical, electromagnetic, infrared, or semiconductor system, apparatus, device, or propagation medium. More specific examples (a nonexhaustive list) of a computer-readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). A computer-readable storage medium is any computer-readable medium configured to store data in a non-transitory manner, including dynamic and/or static RAM, magnetic devices, ROMS, optical storage media (e.g., CD-ROM, DVD), and the like. Note that a computer-readable medium could even be paper or another suitable medium upon which the program associated with investment strategy determination engine 202 is printed, as the program can be electronically captured, via for instance optical scanning of the paper or other medium, then compiled, interpreted, or otherwise processed in a suitable manner, if necessary, and then stored in the memory system 104.

From time to time, program administrators or the like may require access to the investment strategy system 100. For example, portions of the investment strategy determination engine 202 may require revision and/or updating. The optional management terminal 106 (FIG. 1) provides convenient localized access for the administrator. Alternatively, access for an administrator may be available via one of the client terminals 108 or another connected device.

The processor system 102, the memory system 104, the optional management terminal 106, and the router 114, are coupled to a communication bus 210, thereby providing connectivity to the above-described components. In alternative embodiments of the investment strategy system 100, the above-described components may be communicatively coupled to each other in a different manner. For example, one or more of the above-described components may be directly coupled to the processor system 102, or may be coupled to the processor system 102 via intermediary components (not shown).

Asset Contribution, Depletion, and Earning Schedules

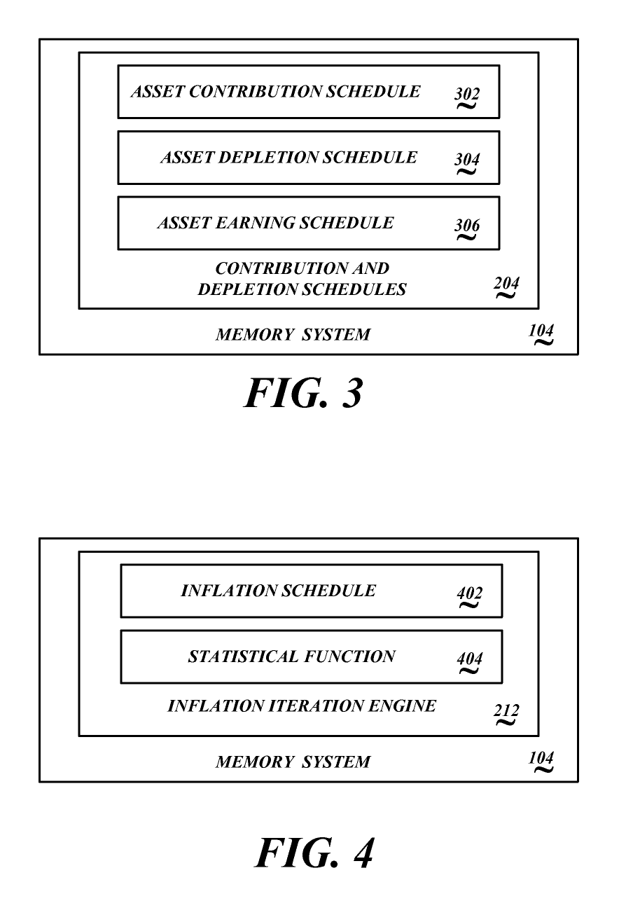

Embodiments of the investment strategy system 100 determine financial strategies based upon, in part, an asset contribution schedule 302, an asset depletion schedule 304, and an asset earning schedule 306, illustrated in FIG. 3. The asset contribution schedule 302, the asset depletion schedule 304, and the asset earning schedule 306, reside in the contribution and depletion schedules 204 region of the memory system 104. In some embodiments, the asset contribution schedule 302, the asset depletion schedule 304, and/or the asset earning schedule 306 reside locally with the processor system 102. In other embodiments, the asset contribution schedule 302, the asset depletion schedule 304, and/or the asset earning schedule 306 may reside remotely, such as, but not limited to, in a memory region of, or accessibly by, the client terminal 108.

The asset contribution schedule 302 defines timing and asset contribution values for each contributed asset made by the client during the contribution years of the financial simulation study period. For example, but not limited to, contribution years may correspond to the career life of the client. Asset contributions may be specified as being received at periodic times and at fixed values, being received at periodic times and at variable values, and/or being received at a predefined time at a fixed value. For example, the client may plan to make periodic payroll deductions for an individual retirement account (IRA) or the like.

Asset contributions may arise from any suitable source, such as salaries, investment returns, anticipated inheritances, anticipated gifts, payouts of deferred and/or qualified retirement plans, pensions, Social Security payments, sale and/or rental of real property, licensing of intellectual property, or the like. As another example, one-time asset contributions, such as from an anticipated sale of an asset such as real estate, may be used to define the asset contribution schedule 302. Or, asset contributions may be made at specified times, such as from an anticipated inheritance or gift, the sale of property, or some other financial windfall

The asset depletion schedule 304 defines a periodic schedule of simulated asset depletions, or withdrawals, made by the client during the depletion years of a financial simulation. For example, but not limited to, depletion years may correspond to the retirement years of the client. The asset depletion schedule 304 represents the client's planned withdrawals of their assets which have been accumulated at the time of a particular withdrawal. For example, the client may define the asset depletion schedule 304 based upon anticipated monthly expenses and/or one-time expenses, such as a house purchase or a vacation.

The periodic asset contributions that define the asset contribution schedule 302 and/or the periodic asset depletions for the asset depletion schedule 304 may be based upon any predefined period. For example, asset contributions and/or depletions may be made on an annual, monthly, or any other suitable periodic basis. Alternatively, or additionally, an asset contribution and/or asset depletion may be made on a one time basis at a specified date. For example, the client may have a trust which becomes available on a specified date. Trust assets may be added to the asset contribution schedule 302 when they become available to the client. As another example, the client may intend to sell their home upon retirement and move to a retirement community. The sale of the client's home would be treated as an asset contribution, and the purchase of the retirement home would be treated as an asset depletion. The home sale and purchase could be at specified dates.

Contribution years and depletion years may overlap each other and/or may be discontinuous with each other. For example, if the client works part time during their retirement, contribution years and depletion years would overlap. If the client takes an extended vacation before starting part time work after retirement, the contribution years may be discontinuous.

Information used to define the asset contribution schedule 302 and the asset depletion schedule 304 may be provided by the client via the client terminal 108. Once the asset contribution schedule 302 and the asset depletion schedule 304 over a specified simulation period has been defined, the investment strategy system 100 may then determine an investment strategy based upon, in part, the asset contribution schedule 302 and the asset depletion schedule 304. The same asset contribution schedule 302 and asset depletion schedule 304 may be used for multiple investment strategies. Alternatively, the asset contribution schedule 302 and/or the asset depletion schedule 304 may be changed so as to provide various investment strategies for the client to consider.

During the study period of the financial simulation, which includes asset contribution years and asset depletion years, the assets earn a return, and thus increase and/or decrease in value as a function of time. For example, if a contributed asset is or includes dollars placed into a bond fund or the like, the value of the asset increases based upon the interest rate associated with the bond fund. The bond fund interest rate is a specified earnings rate provided by the user or another source. The interest rate for that particular bond fund is stored in the asset earnings schedule 306. Thus, the value of the assets in the bond fund increases during the study period of the financial simulation.

Some assets may not be included in a particular financial simulation. For example, real estate may be included as an asset in the client's simulated asset portfolio, but may be selectively omitted in a financial simulation. However, the asset earning schedule 306 may include an earnings schedule for assets that are not considered during a financial simulation. Further, the asset earning schedule 306 may include earnings information for assets that are not included in the simulated asset portfolio. For example, an earning schedule for tax-free municipal bonds may be included in the asset earning schedule 306, but may not be part of the client's simulated asset portfolio.

Asset Portfolio

Upon initialization of a financial simulation, embodiments of the investment strategy system 100 retrieve an initial asset portfolio defining a plurality of assets and associated asset values from the asset portfolio 208. The initial asset portfolio corresponds to the assets, and their associated values, at an initial time corresponding to the beginning of the financial simulation. That is, the initial asset portfolio is adjusted during the first incremental period to determine the value of the asset portfolio 208 at the end of the first incremental period. Then, the value of the asset portfolio 208 at the end of the first incremental period is adjusted during the second incremental period to determine the value of the asset portfolio 208 at the end of the second incremental period. The process continues until the end of the study period is reached. As described herein, asset contributions and asset depletions are added or removed, as specified in the asset allocation schedule 206 and/or the asset depletion schedule 304 respectively, as the current value of the asset portfolio 208 is determined for each incremental period of the study period.

An asset allocation schedule 206 defines how asset contributions are invested in an asset portfolio 208 (FIG. 2). The asset portfolio 208 identifies the types of investments, and the value of the assets, residing in each investment type. For example, investment types may include, but are not limited to, stocks, mutual funds, money market accounts, bonds, bond funds, real estate trusts. Investment types may also include tangible investments, such as, but not limited to, collectibles, real estate, or businesses.

When an asset contribution of cash or the like is made into the client's simulated asset portfolio 208, the contribution may be portioned out into the various investment types in accordance with the predefined asset allocation schedule 206. For example, a hypothetical asset allocation schedule 206 may specify that twenty five percent (25%) of an asset contribution be added into a first mutual fund category of the asset portfolio 208, that twenty five percent (25%) of the asset contribution be added into a second mutual fund category of the asset portfolio 208, that twenty five percent (25%) of the asset contribution be added into a certificate of deposit (CD) of the asset portfolio 208, and that twenty five percent (25%) of the asset contribution be added into a bond fund of the asset portfolio 208.

Some asset contributions may not be allocated in accordance with the asset allocation schedule 206. For example, an asset contribution may correspond to a financial instrument, such as stocks, bonds or the like. As another example, an asset contribution may correspond to real estate, collectibles, or a business interest. Such asset contributions are added directly into the asset portfolio 208.

Over time, the determined value of each type of investment increases based upon the asset contributions made into that type of investment, plus any asset value increase earned during an incremental period by the current assets residing in that investment type. Embodiments of the investment strategy system 100 compute earnings for the various asset types of the asset portfolio 208 in accordance with a predefined asset earning schedule 306. For fixed rate or return investment types, such as a bond fund or CD, the asset earning schedule 306 may be a specified fixed value based upon certain assumptions made by the client and/or their investment advisor. For variable rate or return investment types, such as a mutual funds, real estate, or stocks, the asset earning schedule 306 may be determined in accordance with a specified variable earnings value based upon assumptions made by the client and/or their investment advisor.

For example, a hypothetical mutual fund within the asset portfolio 208 may be valued at $1,000 at a beginning of a particular incremental period. During the incremental period, the client may have specified that $500 would be added into the CD as an asset contribution. Also, the CD may have earned a return of five percent over the period, here assumed to be one year, such that the CD earned $50. Accordingly, the value of the CD at the end of the incremental period would be $1,550. The value of asset types may be determined for any defined incremental period, such as, but not limited to, a year, a month, or even a week. Further, asset types may be evaluated using different incremental periods. For example, the incremental period for valuation of a CD may be one year and the incremental period for valuation of a mutual stock may be a month.

The asset depletion schedule 304 defines at what time asset withdrawals are made. When a withdrawal from the asset portfolio 208 is made, the withdrawal may be portioned out from the various investment types in accordance with the predefined asset depletion schedule 304. The asset allocation schedule 206 defines how the asset depletions are made from existing assets in the asset portfolio 208. For example, a hypothetical asset depletion schedule 304 and the asset allocation schedule 206 may specify that seventy five percent (75%) of an asset contribution be withdrawn from the first mutual fund category of the asset portfolio 208, and that twenty five percent (25%) of the asset withdrawal be made from the second mutual fund category of the asset portfolio 208, until the first and the second mutual funds become exhausted. Then, the asset depletion schedule 304 and asset allocation schedule 206 may then specify that seventy five percent (75%) of the asset withdrawal be from the bond fund of the asset portfolio 208. Any suitable asset depletion schedule 304 and asset allocation schedule 206 may be specified by the client both in terms of which of the financial types in the asset portfolio 208 the withdrawal is to be made from, and when such withdrawals are to be made during the depletion period.

Some asset depletions may not be allocated in accordance with the asset depletion schedule 304. For example, an asset depletion may correspond to real estate, collectibles, or a business interest. Such asset depletions are removed in their entirety from the asset portfolio 208 when that asset is depleted.

In some embodiments, assets may be depleted in accordance with a predefined hierarchy-based strategy. For example, but not limited to, taxable type assets may be withdrawn first. When assets in the specified taxable asset type are depleted, either entirely or to some specified threshold, another type of asset may be selected for depletion. For example, a lower tax rate type asset, or a non-taxed type asset, may be selected for depletion after the first type in the hierarchy. As another example of a hierarchy-based type asset, a relatively high-risk asset may be depleted before lower risk type assets. Various risk assessment criteria may be used, such as bond ratings or the like.

Continuing with the above simplified example of the CD, the asset depletion schedule and the asset allocation schedule 206 may specify that withdrawals of $100 per month be made from the above-described CD, beginning at a specified date. If the hypothetical CD was valued at $1,550 at the end of the above-described incremental asset contribution year when withdrawals are to scheduled to begin thereafter, the value of the CD would be then be decreased by $100 per month. Withdrawals would continue, in accordance with the asset depletion schedule 304, until the value of the CD is exhausted to zero dollars. Further, earnings of the CD during the withdrawal period would be decreasing as the value of the CD becomes reduced. It is appreciated that in this simplified hypothetical example, the CD portion of the asset portfolio 208 would likely become exhausted in approximately sixteen months.

The same asset allocation schedule 206 and/or the asset depletion schedule 304 may be defined for an entire study period such that each asset contribution and/or asset depletion is portioned in the same manner for all incremental periods of a study period. Alternatively, a plurality of asset allocation schedules 206 and/or asset depletion schedules 304 may be defined for particular incremental periods of a study period. Accordingly, asset contributions and/or asset depletions are portioned in accordance with the applicable schedule for the relevant incremental period.

Iteration Engine Overview

The investment strategy system 100 employs one or more iteration engines that determine the value of an asset portfolio over a simulated study period (e.g., 10 years) comprising multiple sequential incremental periods (e.g., 10 year-long periods). Determining the value of an asset portfolio includes determining, for each of the incremental periods, a financial parameter value, such as an inflation value, asset return value, tax value, or the like. Then, for each of the incremental periods, the determined financial parameter is used to determine the change (e.g., increase or decrease) in value of the asset portfolio.

The financial parameter for a given incremental period may be determined by averaging or otherwise aggregating multiple samples of a random variable that represents the possible values of the financial parameter. More specifically, an iteration engine may employ a statistical function, such as a probability distribution that identifies the likelihood of the financial parameter having a particular value. Thus, for a given incremental period, the iteration engine obtains sample values for the financial parameter based on the statistical function, and averages the obtained samples to determine the financial parameter value to use for the incremental period. The statistical function may be a probability distribution, such as a normal (e.g., Gaussian or bell-curve) distribution, uniform distribution, or the like. The statistical function can be represented in various ways, such as an in-memory table of values and corresponding likelihoods, a software function or method that returns random samples based on a symbolic or table-based representation of a probability distribution, or the like.

In some embodiments, the same statistical function is used to model the value of a financial parameter for each incremental period of the study. In other embodiments, different statistical functions can be used to accurately model uncertainty about the future for different incremental periods. For example, if the financial parameter is tax rate, there exists relatively little uncertainty regarding the tax rate during the near future (e.g., during the next several years, the tax rate is unlikely to change significantly from current rates) and relatively more uncertainty regarding the tax rate in the distant future (e.g., there is more uncertainty regarding tax rates 10 or 15 years hence). Thus, the fact that there is more uncertainty in the distant future can be modeled by using a first statistical function (e.g., in the shape of a tight bell curve) for the next five years, and using a second statistical function (e.g., in the shape of a broad bell curve) for periods after five years.

In the following, iteration engines for determining the values of specific financial parameters are described. In particular, the example iteration engines include an inflation iteration engine, an asset return iteration engine, and a tax iteration engine. The described techniques apply to the more general problem of determining any financial parameter based on iterating over a statistical function that represents possible values of the financial parameter. Other types of financial parameters include those tied to specific types of assets (e.g., stocks, bonds, real property), taxes (e.g., capital gains, income), costs and/or losses (e.g., insurance rates, health care costs, etc).

Inflation Iteration Engine

A first embodiment of the investment strategy system 100 employs an inflation iteration engine 212. The inflation iteration engine 212 may, in some embodiments, work cooperatively with other engines, such as, but not limited to, the asset return iteration engine 214 and/or the tax iteration engine 216.

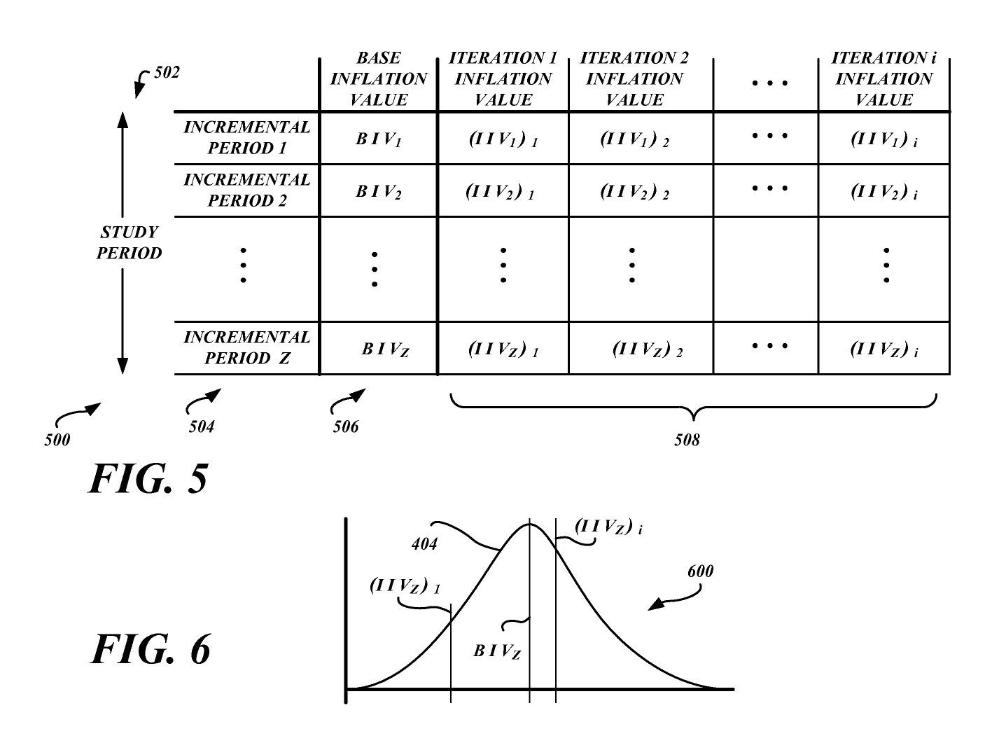

FIG. 4 is a block diagram illustrating selected portions of the inflation iteration engine 212 residing in the memory system 104. The inflation iteration engine 212 includes at least an inflation schedule 402 and a statistical function 404. FIG. 5 illustrates a simplified table 500 which conceptually illustrates the relationship between a study period 502, an incremental period 504, a base inflation value 506, and an iteration inflation value 508. FIG. 6 conceptually illustrates the generation of iteration inflation values 508 based upon the base inflation value 506 and the statistical function 404 (illustrated graphically as a curve 600). The curve 600 is graphed with respect to x (horizontal) and y (vertical) axes, where the x-axis represents inflation values (e.g., in the interval 0.0% to 20%), and the y-axis represents a likelihood that a given inflation value will occur. Thus, the statistical function 404 can be used to sample various possible inflation values for various incremental study periods and/or iterations.

The base inflation values 506, applicable to a particular incremental period 504 of a study period 502, may reside in the inflation schedule 402. A base inflation value 506 is an assumed or predicted inflation value that is applicable to a particular incremental period. Base inflation values 506 typically vary over a study period. Base inflation values 506 may be provided by a third party, may be specified by the user, or predefined.

For each incremental period 504 of a study period 502, the inflation iteration engine 212 performs a series of iterations. For each iteration, the value of inflation (BIV_{Z})ᵢ, where “Z” corresponds to one of the incremental periods 504 and “i” corresponds to the number of iterations made for each incremental period 504, is varied based upon the statistical function 404.

Inflation may be used in a variety of ways by the investment strategy system 100 in the valuation of the asset portfolio 208, and/or in the adjustment of the amount of an asset contribution and/or withdrawal. For example, inflation may be used to adjust earnings of an investment, such as a fixed return investment. Inflation may be used to adjust the specified asset depletion amount for a particular incremental period. Inflation may be used to adjust the asset value over time of a tangible asset such as art or a home.

Conventional economic valuation models and/or processes are configured to apply a single inflation rate over an entire study period. More advanced conventional economic valuation components may allow for variations in inflation on a specified annual or periodic basis. In contrast, embodiments of the inflation iteration engine 212 may determine a unique inflation value for each study period 502. Such embodiments are configured to run a plurality of iterations “i” for each incremental period 504 of a study period 502.

For each iteration “i”, a different iteration inflation value 508 is determined. The determined iteration inflation value 508 is used to determine a valuation of the asset portfolio 208 for that iteration. The number of iterations “i” per incremental period may be predefined or may be specified by the client. Preferably, the number of iterations “i” is relatively large or large enough to reduce error to within an acceptable tolerance (e.g., 5%, 10% or the like). For example, one embodiment of the investment strategy system 100 runs one thousand (1,000) iterations for each incremental period 504. Any suitable incremental period 504 may be defined. For example, an incremental period 504 of one year may be defined for a thirty year study period 502. If a thousand iterations are run for each incremental period 504, thirty thousand iterations would be run during the determination of a single investment strategy that encompasses the thirty year study period 502.

To illustrate, assume that an exemplary study period 502 is thirty years. During the study period 502, the client makes asset contributions to, and asset withdrawals from, their asset portfolio 208. In a hypothetical process of determining an investment strategy, assume that an incremental period 504 of one year is defined. Here, the value of the asset portfolio 208 is computed for each one of the thirty incremental years of the thirty year study period 502.

For each incremental period 504, the base inflation values 506 may be assumed to be a constant or may be assumed to vary. Particular values of the base inflation value 506 are input by the client, their financial advisor, or by another entity. In other embodiments, the inflation schedule 402 is defined each time the asset depletion schedule 304 is used by a client, and/or is defined for each simulated study period 502. For example, the financial advisor may have predefined the base inflation values 506 in the inflation schedule 402 prior to meeting with the client. In another embodiment, the base inflation values 506 in the inflation schedule 402 may be defined by a third party contractor, such as an economic “think-tank” organization comprised of a plurality of expert economic advisors.

When valuing the asset portfolio 208 for a particular incremental period 504, embodiments of the asset portfolio 208 retrieve the specified base inflation value 506 defined in the inflation schedule 402 for that incremental period 504. Then, for each incremental period 504, a number of iterations “i” are performed using an iteration inflation value 508 that is derived from the base inflation value 506 for that incremental period 504.

The iteration inflation value 508 for any particular iteration is determined from a predefined statistical function 404. The iteration inflation value 508 is selected from known values of the predefined statistical function.

Once determined, the iteration inflation value 508 is used to modify the value of the base inflation value 506. In some embodiments, the statistical function 404 conforms to a standardized bell curve. Other embodiments use other statistical functions to determine the iteration inflation value 508. The curve 600 (FIG. 6) conceptually illustrates a hypothetical statistical function 404. Selection of a particular iteration inflation value 508 may be based upon random selection from the statistical function 404, or may be based upon other selection techniques. For example, but not limited to, a Monte Carlo process may be used to determine the iteration inflation value 508 that is used for a particular iteration.

As noted above, for each incremental period 504 (such as a selected year of the study period 502) the base inflation value 506 may be retrieved from the inflation schedule 402. Then, for each iteration wherein valuations of the asset portfolio 208 are determined, an iteration inflation value 508 is determined based upon the statistical function 404. Valuation of the asset portfolio 208 is then determined using the determined iteration inflation value 508.

During the next iteration, a different iteration inflation value 508 is used to determine a valuation of the asset portfolio 208 for that next iteration. When the statistical function 404 is based upon a standardized bell curve, it is appreciated that many of the iterations will use an iteration inflation value 508 that is relatively close to the mean value of the statistical function 404, which corresponds to the base inflation value 506 for that particular incremental period 504. Fewer of the iterations will use an iteration inflation value 508 that is farther away from the base inflation value 506.

After completion of the plurality of iterations for a single incremental period 504, the determined valuations of the asset portfolio 208, each determined using a different iteration inflation value 508, are statistically aggregated to derive an aggregated valuation of the asset portfolio 208 for that particular incremental period. Valuations may be performed using any suitable statistical process. For example, but not limited to, the inflation iteration engine 212 may determine asset valuations using a mean, a mode, or average valuation process.

Inflation may impact other parameters that are considered in determining an investment strategy for a particular study period. For example, the client may define the contribution and depletion schedules 204 using current year values. Inflation adjustments may then be made to reflect the impact of inflation on asset contributions and/or asset withdrawals. For example, assume that a client wishes to have sufficient assets in their asset portfolio 208 to withdraw $50,000 per year for living expenses during the last ten years of a thirty year study period (the incremental years 21-30). In view of inflation, the amount withdrawn from the client's asset portfolio 208 in year 21 will be greater than the specified $50,000. Thus, the year 21 withdrawal amount will be determined based upon the assumed rate of inflation occurring between the incremental years 1-20.

The unexpected benefit of using many iterations for each incremental period 504 of a study period 502 is that, when the valuations for the many iterations are statistically aggregated, a more reliable valuation of the asset portfolio 208 is determined. Thus, the amount of error in a determined financial strategy is reduced.

Asset Return Iteration Engine

A second embodiment of the investment strategy system 100 employs an asset return iteration engine 214. The asset return iteration engine 214 may, in some embodiments, work cooperatively with other engines, such as, but not limited to, the inflation iteration engine 212 and/or the tax iteration engine 216.

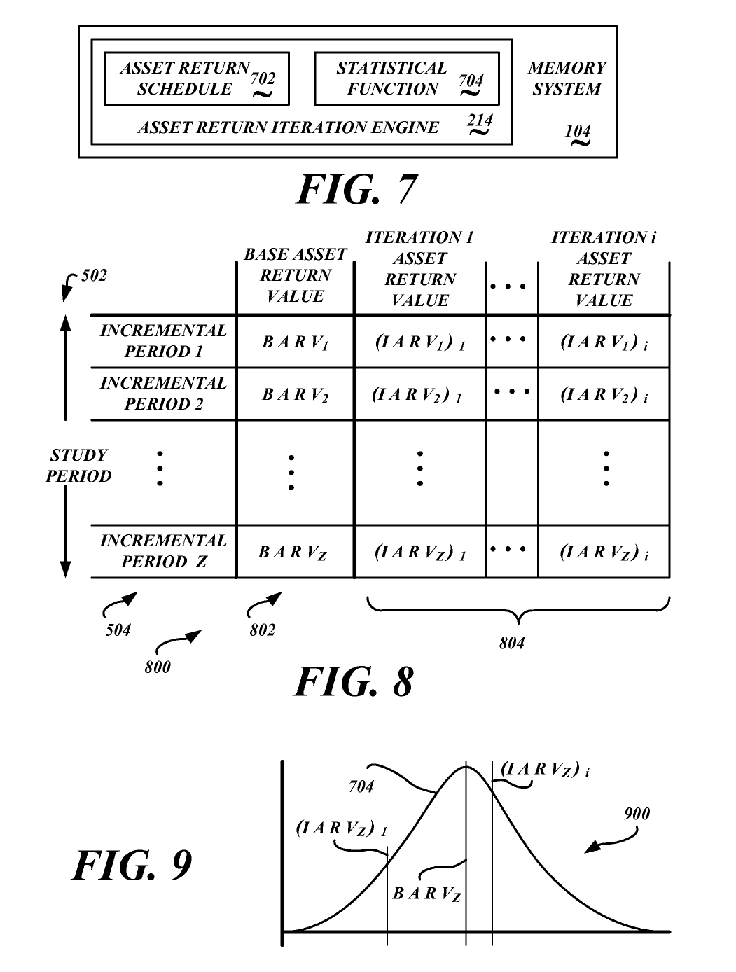

FIG. 7 is a block diagram illustrating selected portions of the asset return iteration engine 214 residing in the memory system 104. The asset return iteration engine 214 includes at least a return schedule 702 and a statistical function 704. The return schedule 702 may be part of, or based upon, the information in the asset earning schedule 306 (FIG. 3).

FIG. 8 illustrates a simplified table 800 which conceptually illustrates the relationship between the study period 502, the incremental periods 504, a base asset return value 802, and an iteration asset return value 804. FIG. 9 conceptually illustrates the generation of iteration asset return values 804 based upon the base return value 506 and the statistical function 704 (illustrated graphically as a curve 900). It is appreciated that the same study period 502 and the incremental periods 504 are used during the financial simulation (see FIG. 5). However, in some embodiments, different incremental periods may be used for asset return simulations.

The base asset return values 802, applicable to a particular incremental period 504 of the study period 502, may reside in the return schedule 702. A base asset return value 802 is an assumed or predicted return value, rate of asset earnings, or the like, that is applicable to a particular incremental period. Base asset return values 802 typically vary over a study period. Base asset return values 802 may be provided by a third party, may be specified by the user, or predefined. The base asset return values 802 are stored in the asset earning schedule 306.

For each incremental period 504 of a study period 502, the asset return iteration engine 214 performs a series of iterations. For each iteration, the base value of return [(BRV_{z})ᵢ, where “Z” corresponds to one of the incremental periods 504 and “i” corresponds to the number of iterations made for each incremental period 504] is varied based upon the statistical function 704.

Asset returns may be used in a variety of ways by the investment strategy system 100 in the valuation of the asset portfolio 208, and/or in the adjustment of the amount of an asset contribution and/or withdrawal. For example, asset returns may be used to adjust earnings of an investment, such as a fixed return investment. Asset returns may be used to adjust the specified asset depletion amount for a particular incremental period. Asset returns may be used to adjust the asset value over time of a tangible asset such as art or a home.

The base asset return values 802 may be based upon any suitable economic asset return methodology, such as ROR, ROA, etc. The base asset return values 802 may vary depending upon the type of asset. For example, a return on bonds or preferred stocks may generate a fixed income. Return on common stocks may vary. Some types of common stocks may be speculative in nature. Other common stocks may be growth type stocks. In some asset types, such as rental properties, may have income that is assumed to increase the same amount as inflation.

Conventional economic asset valuation models and/or processes are configured to apply a single return rate over an entire study period. More advanced conventional economic valuation models may allow for variations in return on a specified annual or periodic basis. In contrast, embodiments of the asset return iteration engine 214 may determine a unique asset return value for each study period 502. Such embodiments are configured to run a plurality of iterations “i” for each incremental period 504 of a study period 502.

For each iteration “i”, a different iteration asset return value 804 is determined. The determined iteration asset return value 804 is used to determine a valuation of the asset portfolio 208 for that iteration. The number of iterations “i” per incremental period may be predefined or may be specified by the client. Preferably, the number of iterations “i” is relatively large or large enough to reduce error to an acceptable level. For example, one embodiment of the investment strategy system 100 runs one thousand (1,000) iterations for each incremental period 504.

To illustrate, assume that an exemplary study period 502 is thirty years. During the study period 502, the client makes asset contributions to, and asset withdrawals from, their asset portfolio 208. In a hypothetical process of determining an investment strategy, assume that an incremental period 504 of one year is defined. Here, the value of the asset portfolio 208 is computed for each one of the thirty incremental years of the thirty year study period 502.

For each incremental period 504, the iteration asset return value 804 may be assumed to be a constant or may be assumed to vary. Particular values of the iteration asset return value 804 are input by the client, their financial advisor, or by another entity. In other embodiments, the return schedule 702 is defined each time the asset depletion schedule 304 is used by a client, and/or is defined for each simulated study period 502. For example, the financial advisor may have predefined the iteration asset return values 804 in the return schedule 702 prior to meeting with the client. In another embodiment, the base asset return values 802 in the return schedule 702 may be defined by a third party contractor, such as an economic “think-tank” organization comprised of a plurality of expert economic advisors.

When valuing the asset portfolio 208 for a particular incremental period 504, embodiments of the asset portfolio 208 retrieve the specified base asset return value 802 defined in the return schedule 702 for that incremental period 504. Then, for each incremental period 504, a number of iterations “i” are performed using an iteration asset return value 804 that is derived from the base asset return value 802 for that incremental period 504.

The iteration asset return value 804 for any particular iteration is determined from a predefined statistical function 704. The iteration asset return value 804 is selected from known values of the predefined statistical function which is used to modify the value of the base inflation value. In some embodiments, the statistical function 704 conforms to a standardized bell curve. Other embodiments use other statistical functions to determine the iteration asset return value 804. The statistical function 704 used for return simulations may be the same, or different from, the statistical function 404 (FIG. 4) used for inflation simulations.

The curve 900 (FIG. 9) conceptually illustrates a hypothetical statistical function 704. Selection of a particular iteration asset return value 804 may be based upon random selection from the statistical function 704, or may be based upon other selection techniques. For example, but not limited to, a Monte Carlo process may be used to determine the iteration asset return value 804 that is to be used for a particular iteration.

As noted above, for each incremental period 504 (such as a selected year of the study period 502) the base asset return value 802 may be retrieved from the return schedule 702. Then, for each iteration wherein valuations of the asset portfolio 208 are determined, an iteration asset return value 804 is determined based upon the statistical function 704. Valuation of the asset portfolio 208 is then determined.

During the next iteration, a different iteration asset return value 804 is used to determine a valuation of the asset portfolio 208 for that next iteration. When the statistical function 704 is based upon a standardized bell curve, it is appreciated that many of the iterations will use an iteration asset return value 804 that is relatively close to the mean value of the statistical function 704, which corresponds to the base asset return value 802 for that particular incremental period 504. Fewer of the iterations will use an iteration asset return value 804 that is farther away from the base asset return value 802.

After completion of the plurality of iterations for a single incremental period 504, the determined valuations of the asset portfolio 208, each determined using a different iteration asset return value 804, are statistically aggregated to derive an aggregated valuation of the asset portfolio 208 for that particular incremental period. Valuations may be performed using any suitable statistical process. For example, but not limited to, the asset return iteration engine 214 may determine asset valuations using a mean, a mode, or average valuation process.

Asset return may impact other parameters that are considered in determining an investment strategy for a particular study period. For example, the client may define the contribution and depletion schedules 204 using current year values. Asset return adjustments may then be made to reflect the impact of returns on asset contributions and/or asset withdrawals. For example, assume that a client wishes to have sufficient assets in their asset portfolio 208 to withdraw $50,000 per year for living expenses during the last ten years of a thirty year study period (the incremental years 21-30). In view of changing asset return assumptions, the amount withdrawn from the client's asset portfolio 208 in year 21 will be different from the specified $50,000. Thus, the year 21 withdrawal amount is determined based upon the assumed rate of return occurring between the incremental years 1-20.

The unexpected benefit of using many iterations for each incremental period 504 of a study period 502 is that, when the valuations for the many iterations are statistically aggregated, a more reliable valuation of the asset portfolio 208 is determined. Thus, the amount of error in a determined financial strategy is reduced.

Tax Iteration Engine

Some types of assets may incur taxes in one form or another. For example, assets that receive earnings, dividends, or rental payments may be subject to federal and/or state income taxes. Some assets may incur capital gains taxes when the asset is sold at a specified time. Various embodiments are configured to integrate tax consequences associated with assets that are included in the simulated asset portfolio. Accordingly, another embodiment of the investment strategy system 100 employs a tax iteration engine 216. The tax iteration engine 216 may, in some embodiments, work cooperatively with other engines, such as, but not limited to, the inflation iteration engine 212 and/or the asset return iteration engine 214. Taxes may be considered on a withholding basis and/or a when paid basis.

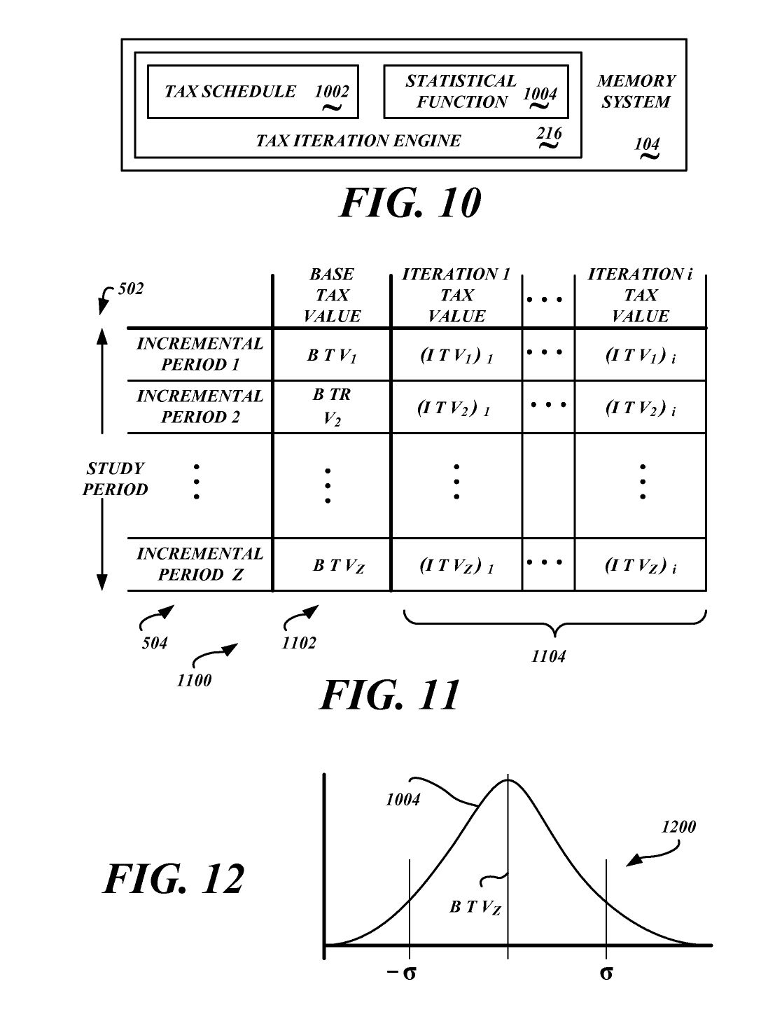

FIG. 10 is a block diagram illustrating selected portions of the tax iteration engine 216 residing in the memory system 104. The tax iteration engine 216 includes at least a tax schedule 1002 and a statistical function 1004. FIG. 11 illustrates a simplified table 1100 which conceptually illustrates the relationship between the study period 502, the incremental periods 504, a base tax value 1102, and an iteration tax value 1104. FIG. 11 conceptually illustrates the generation of iteration tax values 1104 based upon the base tax value 1102 and the statistical function 1004 (illustrated graphically as a curve 1200). It is appreciated that the same study period 502 and the incremental periods 504 are used during the financial simulation (see FIG. 5). However, in some embodiments, different periods may be used for asset tax simulations.

The base tax value 1102, applicable to a particular incremental period 504 of the study period 502, may reside in the tax schedule 1002. For each incremental period 504 of a study period 502, the tax iteration engine 216 performs a series of iterations. For each iteration, the base value of return [(BTV_{z})ᵢ, where “Z” corresponds to one of the incremental periods 504 and “i” corresponds to the number of iterations made for each incremental period 504] is varied based upon the statistical function 1004.

The base tax value 1102 may be based upon any suitable federal, state, and/or special use tax. The base tax values 1102 may vary depending upon the type of and/or location of an asset. For example, a boat may have both a property tax assessment and a special use tax assessment. As another example, the client may reside in a first state, yet have rental property in a second state. The rental property income is subject to taxes in the second state.

It is appreciated that an individual's tax rate varies as a function of income. Accordingly, the base tax value 1102 may also vary based upon the simulated earnings of the client. For example, simulated earnings may be varied to assess and/or optimize tax consequences of the client's earnings. Asset contributions may be directed to, or assets may be reallocated to, investments that are tax free or which have reduced tax rates. Asset depletions may be simulated so as to assess and/or optimize tax consequences of the client's asset depletions.

For each iteration “i”, a different iteration tax value 1104 is determined. The determined iteration tax value 1104 is used to determine a valuation of the asset portfolio 208 for that iteration. The number of iterations “i” per incremental period may be predefined or may be specified by the client. Preferably, the number of iterations “i” is relatively large or large enough to reduce error to an acceptable level. For example, one embodiment of the investment strategy system 100 runs one thousand (1,000) iterations for each incremental period 504.

The iteration tax value 508 for any particular iteration is determined from a predefined statistical function 1104. The iteration tax value 1104 for any particular iteration is determined from a predefined statistical function 1004. The iteration tax value 1104 is selected from known values of the predefined statistical function 1104. Once determined, the iteration tax value 1104 is used to modify the value of the base tax value 1102. In some embodiments, the statistical function 1004 conforms to a standardized bell curve. Other embodiments use other statistical functions to determine the iteration inflation value. The statistical function 1004 used for tax simulations may be the same, or different from, the statistical function 404 (FIG. 4) used for inflation simulations.

The curve 1200 (FIG. 12) conceptually illustrates a hypothetical statistical function 1004. Selection of a particular iteration tax value 1104 may be based upon random selection from the statistical function 1004, or may be based upon other selection techniques. For example, but not limited to, taxes may be varied based upon an expected standard deviation for the taxes. As another nonlimiting example, a Monte Carlo process may be used to determine the iteration tax value 1104 that is to be used for a particular iteration.

The unexpected benefit of using many iterations for each incremental period 504 of a study period 502 is that, when the tax assessments for the many iterations are statistically aggregated, a more reliable valuation of the asset portfolio 208 is determined. Thus, the amount of error in a determined financial strategy is reduced.

### GENERIC EMBODIMENT

A generic two-iteration embodiment may be generally described as retrieving from the memory 104 communicatively coupled to the processor system 102 (or a processor system in a client terminal 108) a base financial parameter value defined for each of the incremental periods of the study period. The base financial parameter value corresponds to one of the above-described base inflation value, the base asset return value, and the base tax value. For a first iteration, an iteration financial parameter value is defined based upon the statistical function associated with the base financial parameter value. The first iteration financial parameter value corresponds respectively to one of the above-described first iteration inflation value, the first iteration asset return value, and the first iteration tax value. For a next iteration, a second iteration financial parameter value is determined based upon the statistical function associated with the base financial parameter value. Similarly, the second iteration financial parameter value corresponds respectively to one of the above-described second iteration inflation value, the second iteration asset return value, and the second iteration tax value. Then, a value of an asset portfolio based upon the first iteration financial parameter value and the second iteration financial parameter value is determined. It is appreciated that many iterations will typically be performed rather than the two above-described iterations. Then, a financial report is generated based upon the determined value of the asset portfolio for each of the incremental periods, wherein the generated financial report indicates changes of the value of the asset portfolio over the time of the study period.

Asset Depletion Engine

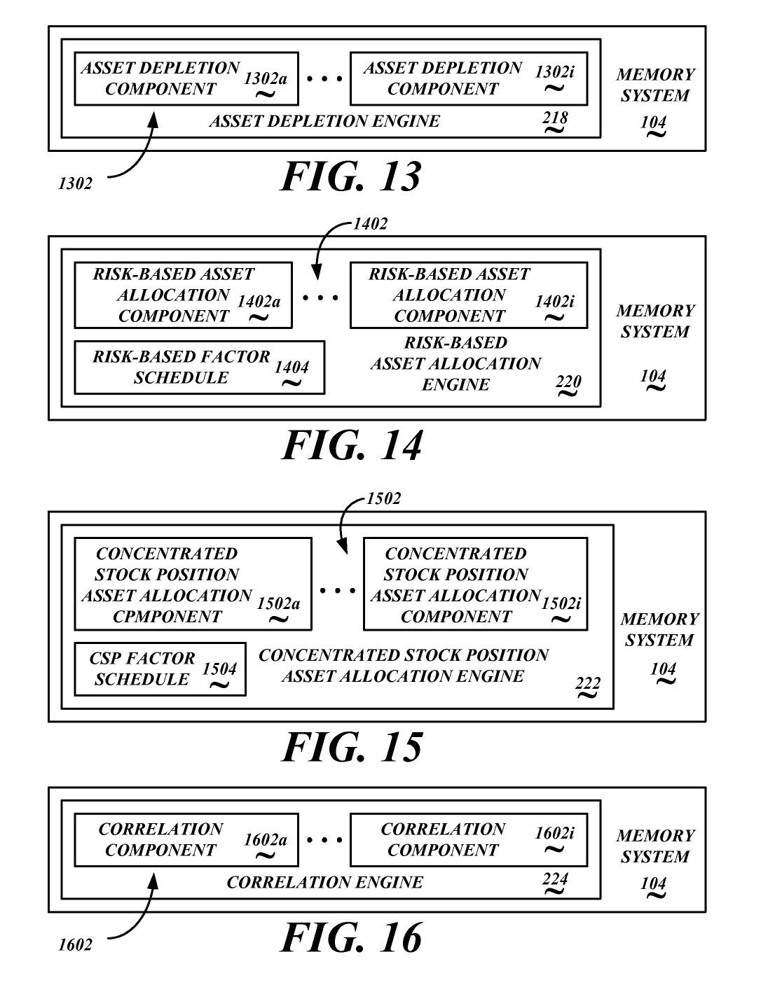

FIG. 13 illustrates an asset depletion engine 218 defined by a plurality of asset depletion components 1302a-1302i. During a financial simulation, the characteristics of asset depletions, or withdrawals, are simulated using one or more asset depletion components 1302a-1302i. As noted above, the timing of an asset depletion is specified in the asset depletion schedule 304.

An exemplary asset depletion component 1302 is a sustainable spending component. Here, a predefined sustainable asset depletion scenario is specified for financial simulation. A sustainable asset depletion scenario is a predefined asset depletion scenario wherein a desired asset depletion schedule is specified. The desired asset depletion schedule is defined by timing of asset depletions during a sustainable spending time period, and is defined by corresponding amounts of asset depletions. The sustainable spending time period has a beginning time and a completion time. However, an initial asset value amount is unknown at the beginning time of the sustainable spending financial simulation. Based upon the specified sustainable spending time period and the specified amounts of asset depletions, the sustainable spending financial simulation determines an initial amount of assets that are required at the beginning time so that sufficient assets are available to support the specified sustainable asset depletion scenario.

The sustainable spending financial simulation may consider asset growth and returns during the sustainable spending time period. Further, tax consequences associated with particular asset depletions may be considered during the sustainable spending financial simulation. In some instances, appropriate asset contributions may be considered in the sustainable spending financial simulation. For example, an expected inheritance, a sale of property, or the like, may be considered. Also, retirement and/or pension income may be considered.

Once the initial amount of assets that are required at the beginning time of the sustainable spending time period are determined, the sustainable spending financial simulation may analyze asset contributions in the time period preceding the sustainable spending time period. That is, the sustainable spending financial simulation may evaluate and/or define an asset contribution schedule, including timing of and amounts of asset contributions, such that the required initial amount of assets is fully funded by the beginning of the sustainable spending time period.

For example, a sustainable spending financial simulation may encompass a study period 502 of thirty-five (35) years. The beginning time of the sustainable spending time period may begin at year twenty-five (25) in this simplified example. Accordingly, years 1-24 would simulate asset contributions. (Further, years 25-35 may also simulate asset accumulations.) Asset contributions, in whole or in part, may be specified as an input to the sustainable spending financial simulation. One or more other asset contribution schedules necessary to fund, or to complete funding of, the initial amount of assets may be determined by the sustainable spending financial simulation.

Continuing with the simplified example, beginning at year 25, a first withdraw, or asset depletion, occurs at a first increment period 504. The value of the asset depletion reduces the current pool of available assets. The remaining available assets support the asset depletions made in the subsequent increment periods 504 up through the year 35.

The specified asset depletion amounts of the sustainable spending financial simulation may be constant over the sustainable spending period. Or, the specified asset depletion amounts may vary in accordance with some predefined formula or the like. For example, the asset depletion amounts may be scaled up or down in view of changing lifestyles of the client, to account for tax consequences associated with particular asset depletions, and/or to account for changes in inflation.

Asset depletions may be determined on any suitable periodic basis, such as annually, monthly, or bi-monthly. Some embodiments may provide for specified variations in the periods selected for asset depletions. Further, specific one-time asset depletions made at a specified incremental period 504 may be specified. For example, exemplary one-time asset depletions may correspond to the purchase of a consumable item or a durable item. Non-limiting examples include purchase of an automobile, a boat, clothes, an appliance, a vacation, a gift, or a home.

At the end of the sustainable spending time period, assets may be depleted to zero dollars. In an alternative scenario, assets may be depleted to some predefined value. For example, the completion time of the terminal wealth asset depletion time period may correspond to the assumed death of the client. If the client wants to reserve some amount of their assets to pass to their heirs, the assets at the end of the sustainable spending time period may correspond to the desired amount of inheritance. As another example, the client may assume that there is a possibility that they may survive the assumed end of the terminal wealth asset depletion time period, and may wish to have assets reserved for further depletion after that time.

Another exemplary asset depletion component 1302 is a terminal wealth component. A terminal wealth asset depletion financial simulation is based upon a specified ending asset value at the completion of terminal wealth time period. The terminal wealth time period has a beginning time and a completion time. Also, an initial asset value is specified for the terminal wealth asset depletion scenario. At the end of the terminal wealth time period, assets may be depleted to zero dollars, or assets may be depleted to some predefined value.

Since the terminal wealth asset depletion scenario is based on a specified terminal wealth time period, an initial asset value at the beginning of the terminal wealth time period, and a desired asset value at the completion of the terminal wealth time period, embodiments are configured to determined a terminal wealth asset depletion schedule over the simulated terminal wealth time period. One or more terminal wealth asset depletion schedules may be determined.

The value and timing of the asset depletions for each increment period 504 are determined such that, at the completion time of the terminal wealth asset depletion financial simulation, the terminal asset value equals the specified asset value at the completion time of an asset depletion period. The specified asset depletion amounts of the terminal wealth asset depletion scenario may be constant over the terminal wealth time period. Or, the specified asset depletion amounts may vary in accordance with some predefined formula or the like. For example, the asset depletion amounts may be scaled up or down in view of changing lifestyles of the client, to account for tax consequences associated with particular asset depletions, and/or to account for changes in inflation.

Risk-Based Asset Allocation Components

FIG. 14 illustrates a risk-based asset allocation engine 220 defined by a plurality of risk-based asset allocation components 1402a-1402i and a risk-based factor schedule 1404. Risk-based factors are used to determine expected value of assets at various times of the risk-based financial simulation. It is appreciated that many factors may influence value of a particular asset type or a particular asset over the time of the study period 502, such as inflation, taxes, and risk. Risk-based factors may be predefined in terms of risk, expected values, or other predicting parameters that are stored in the risk-based factor schedule 1404.

During a risk-based financial simulation, a simulation of asset allocations, or contributions, are simulated using one or more risk-based asset allocation components 1402a-1402i. These risk-based asset allocation components 1402a-1402i may be used to supplement the asset portfolio assets that are allocated in accordance with the information in the asset allocation schedule 206. Risk information is stored in the risk-based factor schedule 1404.

Risk-based factors may be parameterized in a variety of manners. For example, a risk-based factor may be assigned to selected asset types and/or to particular assets. The risk-based factor may be represented as a range of risk spanning from a high risk value to a low risk value. The risk-based financial simulation may use an iterative approach where particular values of a risk-based factor is determined based upon a statistical function. For each incremental period 504 of a study period, an expected risk-based factor for the incremental period 504 is determined based upon the statistical function.

The risk-based asset allocation components 1402a-1402i may be used to define how an asset contribution is allocated among a plurality of different asset investment options in view of risk considerations that may impact the value of an asset over time. A risk-based asset allocation component 1402, based upon some specified risk criteria, may determine percentages, or amounts of, asset allocations (or re-allocations) to particular asset types.

For example, a risk-based factor schedule 1404 may specify acceptable asset risks for various years or increment periods 504 of the simulated study period 502. In a preferred risk-based asset allocation component 1402, a larger percentage of high risk type asset types may be permitted in the early years of a study period 502, and a lower percentage of high risk asset types in later years. The relative degree of acceptable risk, which may vary as time progresses through the study period 502, affects the potential return that the asset receives during the risk-based financial simulation.

For example, in the first years of the study period 502, the risk-based asset allocation component 1402 may specify that ten percent of an asset contribution be allocated to a low risk fixed income type investment, such as preferred stocks or bonds. Also, the risk-based asset allocation component 1402 may specify the remaining ninety percent of the asset contribution be allocated to a relatively risky type of investment, such as growth stocks. During the middle portion of the study period, the risk-based asset allocation component 1402 may specify that one half of an asset contribution be allocated to the fixed income type investment, and may specify the remaining half of the asset contribution be allocated to the relatively risky growth stocks. During the last years of the study period 502, the risk-based asset allocation component 1402 may specify that all asset contributions, if any, are allocated to the fixed income type investment.

A risk-based asset allocation component 1402 may also be configured to shift assets between different asset types based upon some risk-based criteria at various times of the study period 502. For example, the risk factor schedule 1404 may include fixed or variable risk thresholds for particular periods of the financial simulation study period 502. For example, in the early years of the study period, a relatively high degree of risk may be acceptable of all of, or a portion of, an asset portfolio. Thus, assets may be allocated to relatively high risk assets in accordance with the risk factor schedule 1404. During the later years of the study period, the risk threshold may be reduced so that assets are re-allocated to less risky type assets. For example, during the later years of the study period 502, assets may be shifted out of relatively risky growth stocks to less risky preferred stocks or bonds in accordance with the risk factor schedule 1404. Further, when shifting occurs between asset types, the tax iteration engine 216 may account for tax consequences associated with asset shifting.

As assets are allocated and/or shifted between various asset types, the asset return iteration engine 214 determines asset returns based upon asset allocations defined by the various risk-based asset allocation components 1402a-1402i.

Concentrated Stock Position Asset Allocation Components

FIG. 15 illustrates a concentrated stock position asset allocation engine 222 defined by a plurality of concentrated stock position asset allocation components 1502a-1502i and a concentrated stock position (CSP) factor schedule 1504. The concentrated stock position asset allocation components 1502a-1502i simulate management of the asset portfolio. That is, asset contributions, depletions, and/or asset shifts are simulated in accordance with the information in the asset allocation schedule 206.

Legal, contractual, and/or economic restrictions may limit the ability of an asset to be shifted from one asset type to another asset type during certain periods of the financial simulation study period 502. For example, a corporate executive may have common stock, stock warrants, and/or stock options. Such assets may have to be held in that particular asset type for some predefined period to fully vest in ownership or to be eligible for sale in accordance with the corporate executive's contract. Federal and/or state security regulations may dictate allowable divestures of concentrated stock position assets. As another example, the client may hold such a large market share, that the sale of the stocks may result in a significant economic decline in stock value. Accordingly, such stocks should be periodically sold in relatively small portions so as to maintain value of the shares.

Concentrated stock position assets may not be re-allocated or depleted in accordance with the asset allocation schedule 206 or a depletion schedule that manages depletion of other types of assets. Here, the concentrated stock position assets are re-allocated based upon some specified asset de-concentration schedule defined in the concentrated stock position factor schedule 1504. At various predefined periods, concentrated stock position assets allocated may be shifted, or de-concentrated, to other asset types. Once the concentrated stock position has been re-allocated, then the re-allocated asset may be depleted. For example, a stock option, warrant, or similar concentrated stock position, may be converted into common stock, which may then be depleted.

As assets are allocated and/or shifted between various asset types, the concentrated stock position asset allocation engine 222 determines asset returns based upon asset allocations defined by the various concentrated stock position asset allocation components 1502a-1502i. If shifting occurs between asset types, the tax iteration engine 216 may account for tax consequences associated with asset shifting.

Correlation Components

FIG. 16 illustrates a correlation engine 224 defined by a plurality of correlation components 1602a-1602i. Embodiments of the investment strategy system 100 may employ one or more of the correlation components 1602a-1602i which correlate various simulation parameters. Correlation components 1602a-1602i provide for positive correlation or negative correlation between selected simulation parameters. Correlations may be represented as a value between zero (0% of no correlation) to +/−1.0 (100% correlation, with a “+” sign indicating positive correlation and a “−” sign indicating negative correlation).

An exemplary correlation component provides correlation between inflation and return. For example, the correlation between an inflation value and a return value may be defined as +0.75. Thus, a one per unit increase in inflation will cause a 75% adjustment to a return value. For example, assume that the inflation iteration engine 212 statistically determines an inflation value for a particular incremental period 504. Further, assume that the asset return iteration engine 214 determines a return value, for a particular asset, for the same incremental period. When the determined inflation value changes by some amount in a subsequent incremental period 504, a corresponding change in return may be determined based upon the 75% correlation between inflation and return.

Any suitable correlation between selected parameters may be represented in the correlation components 1602. Further, a correlation component may act cooperatively with one of the other components. For example, the asset return iteration engine 214 may cooperatively act with a corresponding correlation component 1602 that correlates inflation and return. Thus, a determined return may be based on other factors modeled by the asset return iteration engine 214 and the correlation between inflation and return.

Reports

In some embodiments, the system 100 generates one or more reports that present or otherwise reflect asset portfolio values determined for multiple incremental study periods.

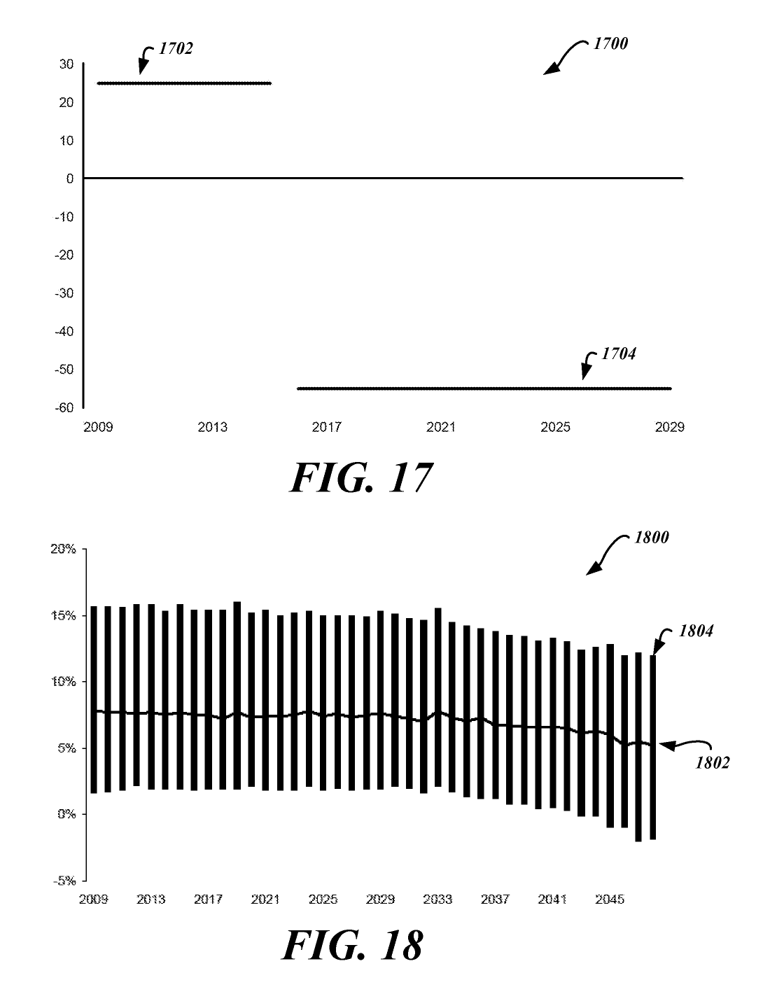

FIG. 17 illustrates an exemplary net asset contributions and depletions output report 1700 presented in graphical form. The net asset contributions and depletions output report 1700 may be selected for presentation at the client terminal 108 (FIG. 1). The contributions 1702 illustrated in the net contributions and withdrawal output report 1700 indicate asset contribution amounts and timing of the asset contributions used for a particular financial simulation. The illustrated depletions 1704 indicate asset depletion amounts and timing of the asset contributions used for a particular financial simulation. Accordingly, the net asset contributions and depletions output report 1700 graphically displays the above described asset contribution schedule 302 and the asset depletions schedule 304 (FIG. 3).

In the various embodiments, in response to a request or instruction, the graphical net asset contributions and depletions output report 1700 is generated by the processor system 102 (or by the processor system of the client terminal 108 if the financial simulation is running locally), and is then presented on the display 116 of the client terminal 108. Alternatively, or additionally, the net asset contributions and depletions output report 1700 may be printed on the printer 118.

FIG. 18 illustrates an exemplary range of returns output report 1800 presented in graphical form. The range of returns output report 1800 may be selected for presentation at the client terminal 108 (FIG. 1). The returns illustrated in the range of returns output report 1800 indicate asset returns amounts and timing of the asset returns used for a particular financial simulation. A portion of the range of expected values of the asset returns for a particular period falls on a corresponding vertical line (bar), for example bar 1804, for that period. The mean expected return is represented by the line 1802. For any given incremental period, the asset return value used for a particular iteration may vary about the mean value based on the predefined statistical function used to determine a particular iteration asset return value, as described hereinabove.

Accordingly, the range of returns output report 1800 graphically displays the above-described asset earning schedule 306 (FIG. 3) and a range by which the iteration asset return values may vary during a set of iterations performed for a particular incremental period.

As the base asset return values are changed based on the predefined statistical function, the determined iteration asset return values are stored for each of the incremental periods of the study period. Then, the stored iteration asset return values for each of the incremental periods are transformed into a range for that particular incremental period. The determined ranges are then time sequenced in accordance with study period to construct the range of returns output report 1800 that is presented in graphical format.

In the various embodiments, in response to a request or instruction, the range of returns output report 1800 is generated by the processor system 102 (or by the processor system of the client terminal 108 if the financial simulation is running locally), and is then presented on the display 116 of the client terminal 108. Alternatively, or additionally, the range of returns output report 1800 may be printed on the printer 118.

Alternatively, or additionally, a range of inflation values report may be constructed from the determined iteration inflation values in a manner similar to the above-described process of constructing the range of returns output report 1800. Further, a range of tax values report may be alternatively, or additionally, constructed from the determined iteration tax values in a similar manner.

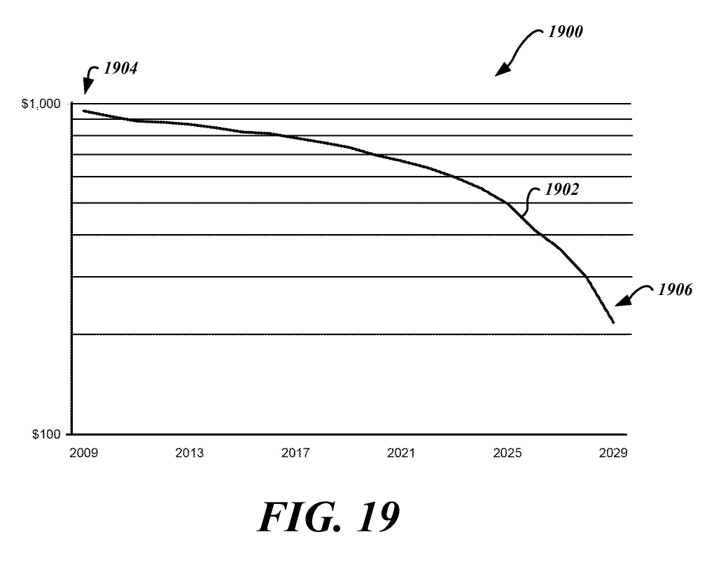

FIG. 19 illustrates an exemplary probable ending value output report 1900 presented in graphical form. The probable ending value curve 1902 corresponds to total asset value for each of the incremental periods of the study period. In this example, the total asset value has an initial value 1906 in year 2009, and then has a final total asset value 1904 in the year 2029. Thus, in this simplified example, it is appreciated that the asset depletions exceeded asset contributions and/or growth, such that the total asset value gradually decreased over the financial simulation period.

In the various embodiments, in response to a request or instruction, the probable ending value curve 1902 is generated by the processor system 102 (or by the processor system of the client terminal 108 if the financial simulation is running locally), and is then presented on the display 116 of the client terminal 108. Alternatively, or additionally, the range of probable ending value curve 1902 may be printed on the printer 118.

Processes

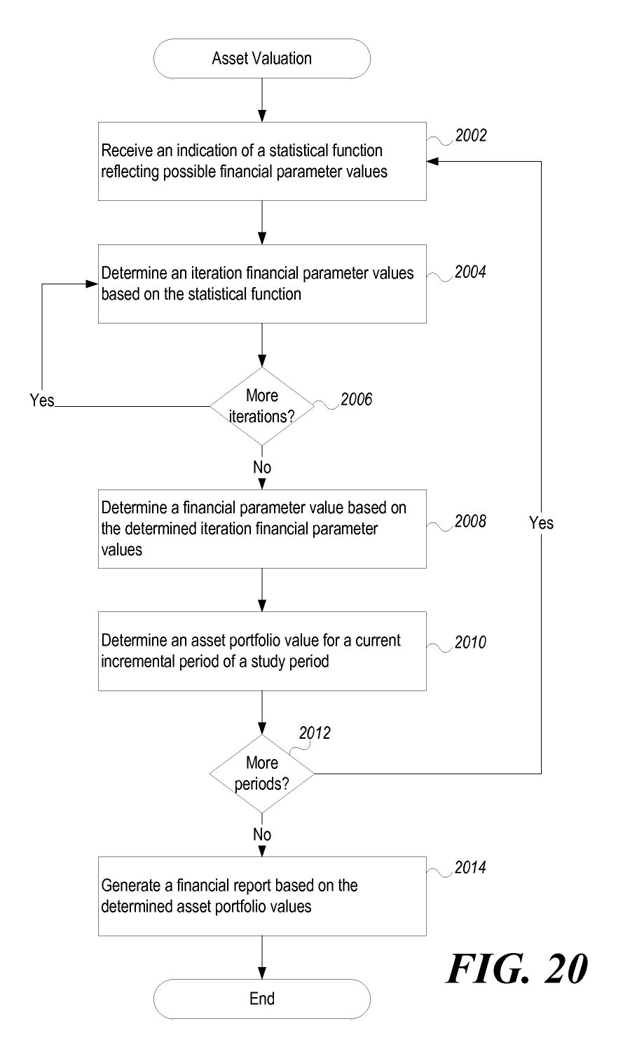

FIG. 20 is an example flow diagram of an asset valuation process performed by an example embodiment. The illustrated process may be implemented by, for example, one or more components of the system 100, such as the investment strategy determination engine 202. The process determines asset valuations based on the iterative approach described with reference to FIGS. 4-12, above.

Between blocks 2002 and 2010, the process performs a loop in which it determines asset portfolio values for each of multiple incremental periods (e.g., years) of a study period (e.g., 20 years). The process begins at block 2002, where it receives an indication of a statistical function reflecting possible financial parameter values. As noted the statistical function may be a probability distribution reflecting financial parameter values, such as tax rate, asset return, inflation, or the like.

At block 2004, the process determines an iteration financial parameter values based on the statistical function. In some embodiments, the process may obtain a random financial parameter value based on the statistical function.

At block 2006, the process determines whether there are more iterations, and if so, continues at block 2004, otherwise at block 2008. Determining whether there are more iterations may include determining whether more than a predetermined number of iterations (e.g., 100, 1000) iterations have been performed. In other embodiments, determining whether there are more iterations may include determining whether an error rate in below a predetermined threshold level (e.g., 5%).

At block 2008, the process determines a financial parameter value based on the determined iteration financial parameter values. In some embodiments, determining the financial parameter value includes aggregating (e.g., averaging) all of the determined iteration financial parameter values to obtain a single financial parameter value for the current incremental period.

At block 2010, the process determines an asset portfolio value for a current incremental period of a study period. Determining the asset portfolio value may include multiplying a value of an asset portfolio (or portion thereof) by the determined financial parameter value to obtain an increase or decrease in the asset portfolio value for the current incremental period.

At block 2012, the process determines whether there are more incremental periods, and if so, continues at block 2002, otherwise at block 2014. For example, if the study period is 20 years, and the incremental period is one year, the process will perform the loop of blocks 2002-2012 20 times.

At block 2014, the process generates a financial report based on the determined asset portfolio values. Generating the financial report may include printing or displaying graphs and/or tables that indicate changes in the value of the asset portfolio under study.

After block 2014, the process ends. In some embodiments this process, or a portion thereof, may be performed for various different financial parameter values (and using different statistical functions), so as to model the impact of various financial assumptions, such as tax rate, asset return, inflation, and the like, upon an asset portfolio.

### ALTERNATIVE EMBODIMENTS

While the preferred embodiment of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method performed in a processor system that defines asset portfolio valuations over a study period, wherein the study period is defined by a plurality of sequential incremental periods, the method comprising:
retrieving an initial asset portfolio defining a plurality of assets and associated asset values from a memory communicatively coupled to the processor system;
performing a plurality of iterations for each of the incremental periods of the study period, wherein each iteration comprises:
retrieving from the memory a base asset return value defined for the incremental period;
determining a plurality of iteration asset return values from a predefined statistical function and the base asset return value, wherein each of the plurality of iteration asset return values represents a possible rate of return of the a value of the plurality of assets of the asset portfolio for the incremental period;
retrieving from the memory a base inflation value defined for the incremental period;
determining a plurality of iteration inflation values from the predefined statistical function and the base inflation value, wherein each of the plurality of iteration inflation values represents a possible rate of inflation affecting the value of the plurality of assets of the asset portfolio for the incremental period;
retrieving from the memory a base tax value defined for the incremental period;
determining a plurality of iteration tax values from the predefined statistical function and the base tax value, wherein each of the plurality of iteration tax values represents a possible tax rate affecting earnings of the plurality of assets of the asset portfolio for the incremental period;
determining an iteration asset portfolio value for the iteration based upon the plurality of iteration asset return values, the plurality of iteration inflation values, the plurality of iteration tax values, and the plurality of asset values of the asset portfolio; and
determining a value of the asset portfolio for each of the incremental periods based upon the iteration asset portfolio values respectively determined for each one of the incremental periods; and
generating a financial report based upon the asset portfolio values determined for each of the incremental periods, wherein the generated financial report indicates changes of the asset portfolio value over the study period.

2. The method of claim 1, wherein generating the financial report further comprises:
storing each of the asset portfolio values determined for each of the incremental periods of the study period;
transforming the asset portfolio values into a probable ending value curve; and
presenting the probable ending value curve on an output device.

3. The method of claim 1, further comprising:
communicating the financial report to a client terminal, wherein the client terminal is remote from the processor system, and wherein the financial report is processed by the client terminal for presentation on an output device communicatively coupled to the client terminal.

4. A method performed in a processor system that defines asset portfolio valuations over a study period, wherein the study period is defined by a plurality of sequential incremental periods, the method comprising:
for at least two iterations for each of the incremental periods of the study period:
from a memory communicatively coupled to the processor system, retrieving a base parameter value defined for the incremental period, wherein the base parameter value corresponds to one of a base inflation value, a base asset return value, and a base tax value;
determining a first iteration parameter value from a predefined statistical function associated with the base parameter value, wherein the first iteration parameter value corresponds respectively to one of a first iteration inflation value, a first iteration asset return value, and a first iteration tax value;
determining a second iteration parameter value from the predefined statistical function associated with the base parameter value, wherein the second iteration parameter value corresponds respectively to one of a second iteration inflation value, a second iteration asset return value, and a second iteration tax value;
determining a parameter value based upon the first iteration parameter value and the second iteration parameter value;
from the memory communicatively coupled to the processor system, retrieving an asset portfolio defining a plurality of assets and associated asset values; and
determining an asset portfolio value for the incremental period based upon the determined parameter value and the plurality of asset values of the asset portfolio; and
generating a financial report based upon the asset portfolio values determined for each of the incremental periods, wherein the generated financial report indicates changes of the asset portfolio value over the study period.

5. The method of claim 4, further comprising:
communicating the financial report to an output device, wherein the financial report is presented by the output device.

6. The method of claim 4, further comprising:
from the memory communicatively coupled to the processor system, retrieving an asset contribution schedule, wherein the asset contribution schedule defines at least one asset contribution defined by a value of the at least one asset contribution and a time of contribution of the at least one asset contribution,
wherein the determined asset portfolio value determined for the time of contribution of the at least one asset contribution includes the value of the at least one asset contribution.

7. The method of claim 4, further comprising:
from the memory communicatively coupled to the processor system, retrieving an asset depletion schedule, wherein the asset depletion schedule defines at least one asset depletion defined by a value of the at least one asset depletion and a time of depletion of the at least one asset depletion,
wherein the determined asset portfolio value determined for the time of depletion of the at least one asset depletion includes the value of the at least one asset depletion.

8. The method of claim 4, further comprising:
communicating the financial report to a client terminal, wherein the client terminal is remote from the processor system, and wherein the financial report is processed by the client terminal for presentation on an output device communicatively coupled to the client terminal.

9. The method of claim 4, wherein generating the financial report further comprises:
storing each of the determined asset portfolio values determined for each of the incremental periods of the study period; and
transforming the determined asset portfolio values into a probable ending value curve.

10. The method of claim 9, further comprising:
presenting the probable ending value curve on an output device.

11. The method of claim 4, wherein generating the financial report further comprises:
for each of the incremental periods of the study period, transforming the determined first iteration parameter value and the determined second iteration parameter value into an iteration parameter value range for each of the incremental periods of the study period.

12. The method of claim 11, further comprising:
presenting the iteration parameter value range for each of the incremental periods of the study period on an output device.

13. The method of claim 11, wherein the first iteration parameter value is a first iteration asset return value, wherein the second iteration parameter value is a second iteration asset return value, and wherein the iteration parameter value range for each of the incremental periods of the study period is based upon the first iteration asset return value and the second iteration asset return value.

14. The method of claim 11, wherein the first iteration parameter value is a first iteration inflation value, wherein the second iteration parameter value is a second iteration inflation value, and wherein the iteration parameter value range for each of the incremental periods of the study period is based upon the first iteration inflation value and the second iteration inflation value.

15. The method of claim 11, wherein the first iteration parameter value is a first iteration tax value, wherein the second iteration parameter value is a second iteration tax value, and wherein the iteration parameter value range for each of the incremental periods of the study period is based upon the first iteration tax value and the second iteration tax value.

16. A computer-readable storage medium whose contents, when executed, cause a processor system to perform a method comprising:
in a processor system, for at least two iterations for each of a plurality of sequential incremental periods of a study period:
receiving a base financial parameter value defined for the incremental period;
determining a first iteration financial parameter value from a predefined statistical function associated with the base financial parameter value;
determining a second iteration financial parameter value from the predefined statistical function associated with the base financial parameter value;
determining a financial parameter value based upon the first iteration financial parameter value and the second iteration financial parameter value;
receiving an asset portfolio defining a plurality of assets and associated asset values; and
determining an asset portfolio value for the incremental period based upon the determined financial parameter value and the plurality of asset values of the asset portfolio; and
generating a financial report based upon the asset portfolio values determined for each of the incremental periods, wherein the generated financial report indicates changes of the asset portfolio value over the study period.

17. The computer-readable storage medium of claim 16 wherein the base financial parameter value, the first iteration financial parameter value, and the second iteration financial parameter value correspond to one of a base inflation value, a base asset return value, and a base tax value.

18. The computer-readable storage medium of claim 16 wherein determining the financial parameter value based upon the first iteration financial parameter value and the second iteration financial parameter value includes averaging the upon the first iteration financial parameter value and the second iteration financial parameter.

19. The computer-readable storage medium of claim 16 wherein the predefined statistical function is a probability distribution associating likelihoods with possible financial parameter values.

20. The computer-readable storage medium of claim 16 wherein a different predefined statistical function is used for at least two of the plurality of sequential incremental periods.
